(19) United States
(12) Patent Application Publication
(10) Pub. No.: US 2009/0131591 A1
(43) Pub. Date: May 21, 2009

(54) ALKOXYSILANE CROSS-LINKED POLYMERS HAVING IMPROVED ELASTIC RECOVERY PROPERTIES

(75) Inventors: Wolfram Schindler, Tuessling (DE); Elke Schwiebacher, Simbach (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/300,699

(22) PCT Filed: May 14, 2007
(86) PCT No.: PCT/EP2007/054637

§ 371 Date: Nov. 13, 2008

(30) Foreign Application Priority Data
May 16, 2006 (DE) 10 2006 022 834.0

(51) Int. Cl. C08F 8/00; C08G 85/00; C08L 83/05

(52) U.S. Cl. 525/105; 525/474; 525/452; 525/431; 525/106

(57) ABSTRACT

Moisture curable alkoxysilyl-functional polymers crosslinkable to elastomers having improved recovery properties are prepared by incorporating in the curable composition, both an aminoalkylalkoxysilane and an epoxyalkylalkoxysilane.

The invention relates to a method for improving the elastic recovery of the crosslinked blends of alkoxysilane-terminated polymers.

Polymer systems having reactive alkoxysilyl groups have been known for a long time. In the presence of atmospheric moisture, these alkoxysilane-terminated polymers are capable of condensing with one another with elimination of the alkoxy groups, even at room temperature. As a function of content of alkoxysilane groups and their structure, the products here are mainly long-chain polymers (thermoplastics), relatively wide-mesh three-dimensional networks (elastomers), or else highly crosslinked systems (thermosets).

The polymers involved here can either be alkoxysilane-terminated polymers having an organic skeleton, e.g. polyurethanes, polyesters, polyethers, etc., described inter alia in EP-A-269 819, EP-A-931 800, WO 00/37533, U.S. Pat. No. 3,971,751, and DE 198 49 817, or else can involve polymers whose skeleton is composed entirely or at least partially of organosiloxanes, described inter alia in WO 96/34030 and U.S. Pat. No. 5,254,657.

There are an infinite number of possibilities for the design of such silane-terminated polymer systems, and correspondingly there is almost complete freedom of adjustment of the properties of the uncrosslinked polymers or of the polymer-containing mixtures (viscosity, melting point, solubilities, etc.), and also the properties of the final crosslinked compositions (hardness, elasticity, tensile strength, elongation at break, heat resistance, etc.). The possible uses of this type of silane-terminated polymer systems are correspondingly varied. By way of example, they can be used to produce elastomers, sealants, adhesives, elastic adhesive systems, rigid and flexible foams, a very wide variety of coating systems, or for mold-making compositions. Any application process can be used for these products, examples being spreading, spraying, casting, pressing, trowelling, etc., as a function of the constitution of the formulations.

Particular properties demanded for applications in the adhesives and sealants sector, alongside the curing of the compositions and the mechanical properties of the vulcanizate, are good adhesion to a very wide variety of substrates, and good elastic properties. Formulations of silane-crosslinking polymers generally exhibit very good properties here.

Adhesion profile is often improved or optimized via addition of organofunctional adhesion promoters. The use of such silanes is prior art and is described in a variety of monographs or publications. Alongside these, there are also specific newly developed adhesion promoter silanes, as described in EP 997469 A or EP 1216263 A, but it is also often useful to use a combination of silanes, as revealed in EP 1179571A.

Adhesives, and particularly sealants, also have to have very good elasticity, alongside good adhesion. A relevant factor here is not only elongation but also relaxation after elongation or compression. This is usually measured in the form of compression set, creep, or recovery. By way of example, ISO 11600 demands recovery above 60% or indeed 70% for elastic sealants.

Elastic behavior is often determined via the formulation, but also via the nature of the main silane-crosslinking polymers. Silicone sealants which use silanes for hardening mostly exhibit excellent recovery behavior here. In other silane-crosslinking polymers, specifically if the polymer has only difunctional terminal groups, often exhibit inadequate recoveries. The formulation then has a decisive effect on properties. By way of example, U.S. Pat. No. 6,576,733 describes a way of improving recovery via a specific catalyst system. It is moreover known that the use of branched polymers increases network density and thus improves elasticity.

The invention provides a method for improving the elastic recovery of the crosslinked polymer blends (P), by using
A) alkoxysilane-terminated polymers (A) having at least one terminal group of the general formula (1)

-A-(CH₂)ₘ—SiR¹ₐ(OR²)₃₋ₐ (1)
where
A is a divalent linking group selected from —O—, —S—, —(R³)N—, —O—CO—N(R³)—, —N(R³)—CO—O—, —N(R³)—CO—NH—, —NH—CO—N(R³)—, —N(R³)—CO—N(R³)—,
R¹ is an unsubstituted or halogen-substituted alkyl, cycloalkyl, alkenyl, or aryl moiety having from 1 to 10 carbon atoms,
R² is an alkyl moiety having from 1 to 6 carbon atoms or an ω-oxaalkylalkyl moiety having a total of from 2 to 10 carbon atoms,
R³ is hydrogen, an unsubstituted or halogen-substituted cyclic, linear, or branched C₁-C₁₁-alkyl moiety or alkenyl moiety, or a C₆-C₁₁-aryl moiety,
a is a whole number from 0 to 2, and
m is a whole number from 1 to 6,
and admixing, with this,
B) aminoalkylalkoxysilane (B) and
C) epoxyalkylalkoxysilane (C).

The additive silane (C) in combination with aminosilanes (B) markedly improves recovery, and this improvement cannot be achieved through use of the individual silanes alone. Fillers such as chalks and silicas alone can have only a slight effect on elastic recovery.

The polymer blends (P) can be formulated as single- or two-component blends. In two-component polymer blends (P), the two silanes (B) and (C) are preferably added to the main component. However, particular preference is given to single-component-curing polymer blends. For the production of the single-component-curing polymer blends it is preferable that silane (C) is first added, then silane (B), since this gives a particularly uniform reaction of the components of the polymer blends (P).

The main chains of the alkoxysilane-terminated polymers (A) that can be used can be branched or unbranched chains. The average chain lengths can be adapted as desired to correspond to the respective properties desired, not only of the uncrosslinked mixture but also of the hardened composition. They can be composed of various units. These are usually polysiloxanes, polysiloxane-urea/urethane copolymers, polyurethanes, polyureas, polyethers, polyesters, polyacrylates and -methacrylates, polycarbonates, polystyrenes, polyamides, polyvinyl esters, or polyolefins, e.g. polyethylene, polybutadiene, ethylene-olefin copolymers, or styrene-butadiene copolymers. It is, of course, also possible to use any desired mixtures or combinations of polymers having various main chains.

There are many known ways of producing polymers (A) having silane terminations of the general formula (1), in particular:
Copolymerization reactions involving unsaturated monomers having groups of the general formula (1). Examples of these monomers would be vinyltrimethoxysilane, vinylmethyldimethoxysilane, (meth)acryloyloxypropyltrimethoxysilane, (meth)acryloyloxymethyltrimethoxysilane, (meth)acryloyloxymethylmethyldimethoxysilane, or else the corresponding ethoxysilyl compounds.
Grafting of unsaturated monomers having groups of the general formula (1) onto thermoplastics, such as polyethylene. Examples of these monomers would be vinyltrimethoxysilane, vinylmethyldimethoxysilane, (meth)acryloyloxypropyltrimethoxysilane, (meth)acryloyloxymethyltrimethoxysilane, (meth)acryloyloxymethylmethyldimethoxysilane, or else the corresponding ethoxysilyl compounds.
Hydrosilylation of H-silanes, such as dimethoxymethylsilane, diethoxymethylsilane, trimethoxymethylsilane, or triethoxysilane, at double bonds which are terminal or are within the chain, mostly with platinum catalysis.

Reaction of a prepolymer (A1) with one or more organosilanes (A2) of the general formula (2)

C—B—(CH₂)ₘ—SiR¹ₐ(OR²)₃₋ₐ (2)
in which R¹, R², R³, m, and a are defined as above,
B is an oxygen atom, nitrogen atom, or sulfur atom, and
C—B— is a functional group which is reactive with respect to suitable functional groups of the prepolymer (A1).

If the prepolymer (A1) here is itself composed of a plurality of units (A11, A12 . . . ), there is no essential requirement that the prepolymer (A1) which is then reacted with the silane (A2) to give the finished polymer (A) is first produced from these units (A11, A12 . . . ) A reversal of the reaction steps is therefore also possible here, by first reacting one or more units (A11, A12 . . . ) with the silane (A2), and only then reacting the resultant compounds with the remaining units (A11, A12 . . . ) to give the finished polymer (A). Examples of prepolymers (A1) composed of units A11, A12 are OH-, NH-, or NCO-terminated polyurethanes and polyureas, where these can be produced from polyisocyanates (unit A11) and from polyols (unit A12).

Preferred polymers (A) having silane terminations of the general formula (1) are silane-terminated polyethers and polyurethanes, particularly preferably polyethers, where these are produced from organosilane (A2) of the general formula (4) and from the prepolymer (A1).

In one preferred mode of production of the polymers (A), preference is given to use of a silane (A2) selected from silanes of the general formula (3)

OCN—(CH₂)ₘ—SiR¹ₐ(OR²)₃₋ₐ (3)

where
R¹, R², R³, and a are defined as above, and
m is equal to 1 or 3.

For production of the polymer (A), it is preferable that the concentrations of all of the isocyanate groups and all of the isocyanate-reactive groups involved in all of the steps of the reaction, and also the reaction conditions, are selected in such a way that all of the isocyanate groups are consumed by reaction during the course of the synthesis of the polymer. The finished polymer (A) is therefore preferably isocyanate-free.

Particularly suitable polyols for the production of the polymers (A) are the aromatic and aliphatic polyester polyols and polyether polyols frequently described in the literature. However, in principle it is possible to use any of the polymeric, oligomeric, or monomeric alcohols having one or more OH functions.

It is preferable that R¹ is a phenyl moiety or alkyl or alkenyl moiety having from 1 to 6 carbon atoms, in particular methyl, ethyl, or vinyl moiety.

It is preferable that R² is an alkyl moiety having from 1 to 3 carbon atoms, in particular methyl moiety or ethyl moiety.

It is preferable that R³ is hydrogen, a phenyl moiety, or alkyl or alkenyl moiety having from 1 to 6 carbon atoms, in particular methyl, ethyl, or n-propyl moiety. m is preferably 1 or 3.

Preferred aminoalkylalkoxysilanes (B) are those of the general formula (4)

R⁷ᵤR⁸ᵥSi(OR⁹)₄₋ᵤ₋ᵥ (4)

in which
R⁷ is an unsubstituted or halogen-substituted alkyl, cycloalkyl, alkenyl, or aryl moiety having from 1 to 10 carbon atoms,
R⁸ is a monovalent, unsubstituted or halogen-substituted C₁-C₃₀-hydrocarbon moiety having SiC-bonded amino group,
R⁹ is an alkyl moiety having from 1 to 6 carbon atoms or an ω-oxaalkylalkyl moiety having a total of from 2 to 10 carbon atoms,
u is 0, 1, or 2, and
v is 1, 2, or 3,
   with the proviso that the sum of u and v is smaller than or equal to 3.

Examples and preferred examples of the moiety R⁷ are listed above for moiety R¹.

Examples and preferred examples of the moiety R⁸ are listed above for moiety R².

Moiety R⁸ is preferably a moiety of the general formula (5)

R¹⁰₂NR¹¹ (5)

in which
R¹⁰ is a hydrogen atom or monovalent, unsubstituted or substituted C₁-C₁₀-hydrocarbon moieties or C₁-C₁₀-aminohydrocarbon moieties, and
R¹¹ is a divalent C₁-C₁₅-hydrocarbon moiety.

Examples of the moiety R¹⁰ are the examples, given for moiety R¹⁰, of hydrocarbon moieties, and also hydrocarbon moieties substituted with amino groups, e.g. aminoalkyl moieties, particular preference being given to the aminoethyl moiety.

Examples of moiety R¹¹ are the methylene, ethylene, propylene, butylene, cyclohexylene, octadecylene, phenylene, and butylene moiety. It is preferable that moiety R¹¹ is divalent hydrocarbon moieties having from 1 to 10 carbon atoms, particularly preferably from 1 to 4 carbon atoms, in particular the n-propylene moiety.

Examples of the moiety R⁸ are aminopropyl, aminoethylaminopropyl, ethylaminopropyl, butylamino-propyl, cyclohexylaminopropyl, phenylaminopropyl, aminomethyl, aminoethyl, aminomethyl, ethylaminomethyl, butylaminomethyl, cyclohexylaminomethyl, phenylamino-methyl groups.

It is preferable that the silane (C) has the general formula (6)

R⁶(CH₂)SiR⁵ₛ(OR⁴)^{3-s} (6)

in which
R⁴ is a methyl, ethyl, or isopropyl moiety,
R⁵ is an unsubstituted or halogen-substituted C₁-C₁₀-hydrocarbon moiety,
R⁶ is an unsubstituted or halogen-substituted C₂-C₂₀-hydrocarbon moiety which has an epoxy group and which can have interruption by ethereal oxygen atoms,
R⁹ is an alkyl moiety having from 1 to 6 carbon atoms,
n is a whole number from 1 to 6, and
s is 0, 1, or 2.

It is preferable that n is the numbers 1 or 3. It is preferable that s is the numbers 1 or 0. It is preferable that R⁵ is a methyl or phenyl moiety. In the case of the C₂-C₂₀-hydrocarbon moiety R⁶ having an epoxy group, the carbon atoms of the epoxy group are included. It is preferable that R⁶ is a moiety of the general formula (7)

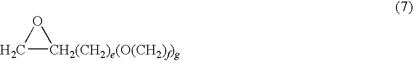

in which
e is 0, 1, or 2,
f is 1, 2, or 3, and
g is 0, 1, 2, or 3.

Preferred examples of the moiety R⁶ are glycidoxy and (3,4-epoxycyclohexyl)ethyl moieties.

The proportion of alkoxysilane-terminated polymers (A) in the polymer blends (P) is preferably from 10 to 70% by weight, particularly preferably from 15 to 50% by weight, in particular from 20 to 40% by weight. The proportion of aminoalkylalkoxysilane (B) is preferably from 0.1 to 10% by weight, particularly preferably from 0.1 to 5% by weight, in particular from 0.2 to 3% by weight. The proportion of silane (C) is preferably from 0.1 to 10% by weight, particularly preferably from 0.5 to 5% by weight, in particular from 1 to 3% by weight.

The polymer blends (P) can comprise condensation catalysts, for example titanate esters, such as tetrabutyl titanate, tetrapropyl titanate, tetraisopropyl titanate, tetraacetylacetonate titanate; Tin compounds, such as dibutyltin dilaurate, dibutyltin maleate, dibutyltin diacetate, dibutyltin dioctanoate, dibutyltin acetylacetonate, dibutyltin oxide, or corresponding compounds of dioctyltin; basic catalysts which can be identical with the aminoalkylalkoxysilane (B), e.g. aminopropyltrimethoxy-silane, aminopropyltriethoxysilane, N-(2-aminoethyl)-aminopropyltrimethoxysilane, and other organic amines, such as triethylamine, tributylamine, 1,4-diazabicyclo[2.2.2]octane, N,N-bis(N,N-dimethyl-2-aminoethyl)methylamine, N,N-dimethylcyclohexylamine, N,N-dimethylphenylamine, N-ethylmorpholine, etc.; acidic catalysts, such as phosphoric acid or phosphoric esters, toluenesulfonic acids, mineral acids. Preference is given to aminosilanes alone or in combination with dibutyltin compounds.

The concentrations preferably used of the condensation catalysts are from 0.01 to 10% by weight, particularly preferably from 0.1 to 2% by weight, of the polymer blends (P).

The various catalysts can be used either in pure form or else in the form of mixtures.

The polymer blends (P) can comprise fillers, for example calcium carbonates in the form of natural ground chalks, ground and coated chalks, precipitated chalks, precipitated and coated chalks, clay minerals, bentonites, kaolins, talc, titanium dioxides, aluminum oxides, aluminum trihydrate, magnesium oxide, magnesium hydroxide, carbon blacks, precipitated or fumed silicas. The concentrations preferably used of the fillers are from 10 to 70% by weight, particularly preferably from 30 to 60% by weight, of the polymer blends (P).

The polymer blends (P) can comprise water scavengers and silane crosslinking agents, e.g. vinylsilanes such as vinyltrimethoxy-, vinyltriethoxy-, vinylmethyl-dimethoxy-, O-methylcarbamatomethylmethyldimethoxy-silane, O-methylcarbamatomethyltrimethoxysilane, O-ethylcarbamatomethylmethyldiethoxysilane, O-ethyl-carbamatomethyltriethoxysilane, and generally alkylalkoxysilanes, or else other organofunctional silanes. The concentrations preferably used of the water scavengers and silane crosslinking agents are from 0.1 to 10% by weight, particularly preferably from 0.5 to 2% by weight, of the polymer blends (P).

The polymer blends (P) can comprise plasticizers, e.g. phthalate esters, such as dioctyl phthalate, diisooctyl phthalate, diundecyl phthalate, adipic esters, such as dioctyl adipate, benzoic esters, glycol esters, phosphoric esters, polyesters, polyethers, polystyrenes, polybutadienes, polyisobutenes, paraffinic hydrocarbons, higher, branched hydrocarbons, etc.

The concentrations preferably used of the plasticizers are up to 40% by weight of the polymer blends (P).

The polymer blends (P) can comprise agents with thixotropic effect, e.g. hydrophilic fumed silicas, coated fumed silicas, precipitated silicas, polyamide waxes, hydrogenated castor oils, stearate salts, or precipitated chalks. The abovementioned fillers can also be utilized to adjust flow properties.

The concentrations preferably used of the agents with thixotropic effect are from 1 to 5% by weight of the polymer blends (P).

The polymer blends (P) can moreover comprise light stabilizers, such as those known as HALS stabilizers, fungicides, flame retardants, pigments, etc., these being those known for use in conventional alkoxy-crosslinking single-component compositions.

To produce the respective desired property profiles, both of the uncrosslinked polymer blends (P) and also of the hardened compositions, it is preferable to use the above additives.

For the production of the polymer blends (P) it is preferable first to prepare a mixture composed of polymer (A) and filler, then to incorporate silane (C) by mixing, and then to admix aminoalkylalkoxysilane (B).

There is an enormous number of different applications for the polymer blends (P) in the field of adhesives and sealants, including joint sealants, and surface coatings, and also in the production of mold-making materials and of moldings.

The polymer blends (P) here are suitable for an enormous variety of substrates, e.g. mineral substrates, metals, plastics, glass, ceramics, etc.

The definitions of each of the above symbols in the above formulae are independent of one another. The silicon atom is tetravalent in all of the formulae.

Unless otherwise stated, all amounts and percentages stated in the following examples are based on weight.

### EXAMPLES

### Examples 1

### Formulations Using a Silane-Terminated Polyether Having Methylenemethyldimethoxysilyl Terminal Groups (Alpha-Dimethoxy)

125 g of the silane-terminated polyether obtainable as GENIOSIL® STP-E10 from Wacker Chemie AG are mixed with 75 g of diisodecyl phthalate (Merck) and 10 g of vinyltrimethoxysilane obtainable as GENIOSIL® XL10 (Wacker Chemie AG), at 200 rpm for 2 minutes at about 25° C. in a laboratory planetary mixer from PC-Laborsystem, equipped with two cross-arm mixers. 10 g of a hydrophilic silica, HDK® V15 (Wacker Chemie AG) are then incorporated by stirring until homogeneously dispersed. 252 g of BLR³ chalk (Omya) are then introduced, and the filler is destructured with stirring for one minute at 600 rpm. After incorporation of the chalk, 5 g of glycidoxypropyltrimethoxysilane (GENIOSIL® GF80—Wacker Chemie AG) are dispersed at 200 rpm for 1 minute. Finally, 5 g of aminopropyltrimethoxysilane (GENIOSIL® GF96—Wacker Chemie AG) are dispersed at 200 rpm for 1 minute, and the mixture is homogenized for 2 minutes at 600 rpm and 1 minute at 200 rpm under partial vacuum (about 100 mbar), with stirring to remove bubbles.

The formulation is drawn off into 310 ml PE cartridges and stored at 25° C. for one day.

Comparative examples 1b and 1c are produced analogously. Table 1 gives the results.

TABLE 1

| | | Comparative | Comparative |
|---|---|---|---|
| | Example 1a | example 1b* | example 1c* |
| GENIOSIL ® STP-E10 | 25% | 30% | 30% |
| Diisodecyl phthalate | 15% | 15% | 30% |
| GENIOSIL ® XL 10 | 2% | 2% | 1% |
| HDK ® V 15 | 2% | | |
| HDK ® H18 | | 3% | 3% |
| Chalk-Carbital 110 | 54% | | |
| Chalk Omya ® BLR 3 | | 50% | 35% |
| GENIOSIL ® GF 80 | 1% | | |
| GENIOSIL ® GF 96 | 1% | 1% | 1% |
| Skinning time | 46 min | 38 min | 52 min |

Vulcanizate to DIN 53504 and DIN 53505

| | | | |
|---|---|---|---|
| S1 modulus in N/mm² | 2.15 | 0.89 | 0.56 |
| Shore A | 62 | 48 | 32 |
| S1 elongation at | 107 | 289 | 268 |
| break in % | | | |
| S1 ultimate tensile | 2.2 | 1.1 | 0.8 |
| strength in N/mm² | | | |
| Resilience | 50% | 20% | 26% |
| (ISO 7389; after 4 | | | |
| weeks at RT) | | | |

*not of the invention

### Determination of Mechanical Properties

The specimens are spread at a depth of 2° mm on Teflon® plaques produced by milling, and cured for 2 weeks at 23° C., rel. humidity 50.

Mechanical properties are determined to DIN 53504 (tensile test) and DIN 53505 (Shore A hardness). Recovery is measured to ISO 7389 after four weeks of prior storage of the H test specimens at 23° C., rel. humidity 50. Recovery is determined using test specimens elongated by 25%.

Comparative examples 1b and 1c show that the filler does not have much effect.

### Examples 2

### Formulations Using a Silane-Terminated Polyether Having Propylenetrimethoxysilyl Terminal Groups (Gamma-Trimethoxy)

Preparation of the Formulations and Testing of mechanical properties of Examples 2a-c of the invention and of Examples 2d-e, not of the invention, is carried out analogously with Example 1. GENIOSIL® STP-E35 (Wacker Chemie AG) is used as polymer.

Table 2 lists the values:

TABLE 2

| | Example | | | | |
|---|---|---|---|---|---|
| | 2a | 2b | 2c | 2d* | 2e* |
| GENIOSIL ® STP-E35 | 20.0% | 20.0% | 21.0% | 20.0% | 22.0% |
| Diisodecyl phthalate | 40.0% | 40.0% | 41.0% | 40.0% | 42.0% |
| GENIOSIL ® XL 10 | 1.0% | 2.0% | 2.0% | 2.0% | 2.0% |
| GENIOSIL ® XL 65 | 1.0% | | 1.0% | 1.0% | |
| GENIOSIL ® GF 80 | 1.0% | 1.0% | 1.0% | | |
| HDK ® H18 | 3.0% | 3.0% | | 3.0% | |
| Chalk-Socal U1S2 | 33.0% | 33.0% | 33.0% | 33.0% | 33.0% |
| GENIOSIL ® GF 96 | 1.0% | 1.0% | 1.0% | 1.0% | 1.0% |
| Dibutyltin dilaurate | 0.25% | 0.25% | 0.25% | 0.25% | 0.25% |
| Skinning time | 18 min | 18 min | 23 min | 25 min | 11 min |

Vulcanizate to DIN 53504 and DIN 53505

| | | | | | |
|---|---|---|---|---|---|
| S1 modulus in N/mm² | 0.58 | 0.70 | 0.43 | 0.29 | 0.33 |
| Shore A | 27 | 33 | 23 | 20 | 20 |
| S1 elongation at | 296 | 254 | 192 | 759 | 382 |
| break in % | | | | | |
| S1 ultimate tensile | 1.4 | 1.4 | 0.8 | 1.6 | 1.2 |
| strength in N/mm² | | | | | |
| Resilience | 95% | 96% | 94% | 53% | 77% |
| (ISO 7389; after 4 | | | | | |
| weeks at RT) | | | | | |

*not of the invention

1-7. (canceled)

8. A method for improving the elastic recovery of crosslinked polymer blends, by crosslinking a crosslinkable composition comprising:
A) at least one alkoxysilane-terminated polymer having a main chain and at least one terminal group of the formula (1)
-A-(CH₂)ₘ—SiR¹ₐ(OR²)₃₋ₐ (1)
where
A is a divalent linking group selected from the group consisting of —O—, —S—, —(R³)N—, —O—CO—N(R³)—, —N(R³)—CO—O—, —N(R³)—CO—NH—, —NH—CO—N(R³)—, and —N(R³)—CO—N(R³)—,
R¹ is an unsubstituted or halogen-substituted alkyl, cycloalkyl, alkenyl, or aryl moiety having up to 10 carbon atoms,
R² is an alkyl moiety having from 1 to 6 carbon atoms or an ω-oxaalkylalkyl moiety having a total of from 2 to 10 carbon atoms,
R³ is hydrogen, an unsubstituted or halogen-substituted cyclic, linear, or branched C₁-C₁₈-alkyl moiety or C₂-C₁₈ alkenyl moiety, or a C₆-C₁₈-aryl moiety,
a is a whole number from 0 to 2, and
m is a whole number from 1 to 6,
B) at least one aminoalkylalkoxysilane (B) and
C) at least one epoxyalkylalkoxysilane (C).

9. The method of claim 8, in which a main chain of the alkoxysilane-terminated polymers (A) comprise a polymer selected from the group consisting of polysiloxanes, polysiloxane-urea/urethane copolymers, polyurethanes, polyureas, polyethers, polyesters, polyacrylates and -methacrylates, polycarbonates, polystyrenes, polyamides, polyvinyl esters, polyolefins, polybutadiene, ethylene-olefin copolymers, and styrene-butadiene copolymers, and mixtures and combinations of at least one of these main chains with another polymer main chain.

10. The method of claim 8, wherein the polymers (A) are obtained through reaction of silanes of the formula (3)
OCN—(CH₂)ₘ—SiR¹ₐ(OR²)₃₋ₐ (3),
where
m is equal to 1 or 3,
with at least one polyester polyol or polyether polyol.

11. The method of claim 8, wherein R² is an alkyl moiety having from 1 to 3 carbon atoms.

12. A polymer blend (P) of claim 8, wherein at least one m has the value 1.

13. The method of claim 8, wherein a single-component-curing polymer blend is produced.

14. The method of claim 13, wherein silane (C) is first added and then silane (B) is added.
